(19) United States
(12) Patent Application Publication
(10) Pub. No.: US 2011/0143617 A1
(43) Pub. Date: Jun. 16, 2011

(54) Reinforced liquid silicone rubber sheeting and method for its manufacture

(76) Inventors: Daniel De La Vega, II, Paso Robles, CA (US); Allen C. Rasor, SR., San Luis Obispo, CA (US)

(21) Appl. No.: 12/653,267

(22) Filed: Dec. 11, 2009

(51) Int. Cl. B32B 25/20; B05D 3/02; B32B 3/26; B32B 5/02; B32B 25/10

(52) U.S. Cl. 442/43; 427/387; 428/317.9; 442/1; 442/181

(57) ABSTRACT

Reinforced silicone rubber sheeting (92) is formed. A first layer (34) of uncured liquid silicone rubber (LSR) is applied to a continuous carrier film (14). A continuous reinforcing fabric (46) is placed onto the first layer (34) of uncured LSR. A second layer (68) of uncured LSR is then applied onto the continuous reinforcing fabric (46) to completely encapsulate the fabric (46) in LSR. The first layer (34) and second layer (68) of LSR are then heat cured to complete the sheeting. The reinforced silicone rubber sheeting (92) of the present invention includes a cured LSR (34′ and 68′) overlying a continuous carrier film (14), and a continuous reinforcing fabric (46) completely encapsulated within the cured LSR (34′ and 68′).

### FIELD OF THE INVENTION

The invention herein disclosed and claimed relates to liquid silicone rubber articles and, more particularly, to reinforced liquid silicone rubber sheeting and a method for manufacture of such sheeting.

### BACKGROUND OF THE INVENTION

Liquid silicone rubber formulations (LSR) are known in the art. LSR is commercially available as a system of liquid or paste-like components. For example, a first component of organopolysiloxane polymer and a second component of organosiloxane crosslinker are mixed in the presence of a reaction catalyst. The polymer and crosslinker react. In this reaction, cross-linkages occur that result in the formation solid silicone rubber.

The organopolysiloxane polymer and organosiloxane crosslinker components are typically referred to as the “A” and “B” components of the liquid silicone rubber. Such a system is typically described as two-part LSR. The reaction catalyst, such as platinum, may be added to the LSR at the reaction time. Alternatively, the catalyst may be present in the LSR but prevented from catalyzing the cross-linking reaction due the presence of another component, called an inhibitor. For example, acetylenic alcohol is known to prevent platinum from catalyzing LSR. By including acetylenic alcohol as the inhibitor, a ready-to-use, two-part, LSR may be manufactured. When this two-part LSR is dispensed, the inhibitor is removed by evaporation of decomposition via a heating step. With the inhibitor removed, the catalyst causes the A and B components to react to form solid silicone rubber.

Silicone rubbers exhibit many useful characteristics. Advantageous properties of silicone rubber include thermal stability over of a large temperature range, ability to repel water (hydrophobicity), resistance to environmental breakdown, flexibility, usefulness as an electrical insulator, low chemical reactivity, high gas permeability, and low toxicity. As a result of these properties, silicone rubbers are used in a variety of mechanical, electrical, and medical applications.

One disadvantage of silicone rubber, however, is that it has relatively poor tensile strength as compared to, for example, natural rubber. As a result, devices of pure silicone rubber are easily damaged when subjected to tensile, or pulling, stresses. To improve tensile strength, a reinforcing material may be added to the silicone rubber. Typical reinforcement materials include filler material, such as silica, or structural components, such as paper, fabric, or metal webbing. The combination of silicone rubber and reinforcing material is typically called reinforced silicone rubber.

Thin layers of reinforced silicone rubber are called sheeting. Reinforced silicone rubber sheeting is typically produced using a high consistency silicone rubber rather than liquid silicone rubber. High consistency silicone rubber is formulated with highly viscous polymers. Because the polymers are so viscous, high consistency silicone rubbers exhibit good “green” strength. That is, high consistency silicone rubber holds an extruded profile even when uncured. As a result, uncured, high consistency silicone rubber may be handled without risk of tearing. However, this advantage comes at a significant cost in process complexity.

In a typical silicone rubber sheeting process, high consistency silicone rubber must be compounded, on site, prior to use. Compounding is performed by repeatedly passing the high consistency silicone rubber through a two-roll mill to reverse any hardening of its elastomer and to blend in additional materials. Once the high consistency silicone rubber is fully compounded, it must then be hand cut into strips of proper size. The reinforcement material is then laid up, by hand, prior to further milling and pressing. Manufacture of reinforced silicone sheeting using high consistence silicone rubber requires expensive machines, complex setups, and substantial direct labor. In addition, high consistency silicone rubber reinforced sheeting cannot be economically manufactured to close thickness tolerances. Thickness tolerances of +/−10%, or more, are not uncommon in the art. Finally, the physical constraints of the manufacturing process restrict the maximum sheeting size. Typical processes are only capable of maximum sheeting sizes of about 12 inches by 12 inches.

Several issued US patents related to the manufacture of reinforced silicone rubber sheeting using liquid silicone rubber. U.S. Pat. No. 6,709,752 to James et al discloses a pressure barrier fabric formed by coating organopolysiloxanes (LSR) onto one side of a fabric. This process uses LSR chemistry modified to make the resulting fabric impermeable to gas. One side of the fabric is left uncoated. However, this process is not suitable for maintaining tight thickness tolerances.

U.S. Pat. No. 6,930,063 to Keese discloses a non-curling, reinforced membrane. A reinforcing fabric, such as glass fiber, is enclosed in a perfluoropolymer (PTFE) layer. A cured, LSR layer is adhered to the PTFE and glass fiber composite using a bonding agent. This method requires multiple materials and a complex set of steps to form the sheeting.

U.S. Pat. No. 5,919,476 to Fischer et al discloses a reinforced silicone gel bandage for use in scar tissue treatment. A laminate of tacky silicone gel, mesh fabric, and non-tacky silicone is formed. However, the tacky silicone gel, even when combined with mesh fabric, is only useful for bandaging due to a lack of material strength.

U.S. Pat. No. 6,534,126 to Blackwood et al discloses a method to form a silicone rubber sheeting composite. After LSR is applied to a base fabric, an aqueous suspension of powdered silicone rubber is sprayed onto the LSR-fabric sheeting. The sheeting is then heat cured, which causes the silicone rubber powder to permanently adhere. As a result, the surface tackiness of the LSR is reduced. This method is not suitable for producing sheeting with close thickness tolerances.

U.S. Pat. Nos. 4,820,170 and 4,918,814, each to Redmond et al, disclose a method to make a layered, electrical connector material. A first LSR is coated and cured onto a carrier film. A second LSR layer is coated onto the first LSR layer, and a conductive paper is placed over the second LSR layer. After heat-curing, a primer layer is sprayed onto the exposed paper layer, and the carrier film is removed. Squares of the material are cut, stacked, pressed, and heated so that the primer layer adheres to the first LSR layer of each stacking square. This method requires a series of complex, hand-performed steps.

A primary objective of the present invention is to provide an efficient and effective method to form continuous, reinforced silicone rubber sheeting using liquid silicone rubber. Another object is to produce continuous, reinforced silicone rubber sheeting with large sheeting widths. Another object is to produce continuous, reinforced silicone rubber sheeting where the reinforcing material is completely encapsulated. Another object is to produce continuous, reinforced silicone rubber sheeting that is gas permeable. Another object is to produce continuous, reinforced silicone rubber sheeting with tight thickness tolerances.

### BRIEF DESCRIPTION OF THE DRAWINGS

The present invention and the corresponding advantages and features provided thereby will be best understood and appreciated upon review of the following detailed description of the invention, taken in conjunction with the following drawings, where like numerals represent like elements, in which:

FIG. 1 is a simplified schematic diagram of an exemplary method for making reinforced silicone rubber sheeting in accordance with one embodiment of the invention;

FIGS. 2 through 6 are cross sectional views illustrating an exemplary reinforced silicone rubber sheeting at sequential steps in its method of formation and in accordance with one embodiment of the invention;

FIG. 7 is a top view of an exemplary reinforced silicone rubber sheeting illustrating trimming the width of the sheeting in accordance with one embodiment of the invention; and

FIG. 8 is a simplified schematic diagram of an exemplary method for making reinforced silicone rubber sheeting in accordance with the invention.

### DETAILED DESCRIPTION OF THE INVENTION

A method of the present invention provides continuous, reinforced silicone rubber sheeting using liquid silicone rubber. In an exemplary embodiment of the present invention, reinforced silicone rubber sheeting is formed by providing a continuous carrier film. A first layer of uncured liquid silicone rubber is applied to the continuous carrier film. A continuous reinforcing fabric is placed onto the first uncured liquid silicone rubber. A second layer of uncured liquid silicone rubber is then applied onto the continuous reinforcing fabric to completely encapsulate the fabric in liquid silicone rubber. The first and second silicone rubber layers are then heat cured to complete the sheeting.

The method is efficient and effective for producing continuous, reinforced silicone rubber sheeting from liquid silicone rubber. The manufacturing process is simple. It does not require operator hand layup or complicated calendering setups. The method is useful for producing large sheeting widths, continuous lengths, and close thickness tolerances.

The reinforced silicone rubber sheeting of the present invention includes a continuous carrier film, a cured liquid silicone rubber overlying the continuous carrier film, and a continuous reinforcing fabric completely encapsulated within the cured liquid silicone rubber. The complete encapsulation of the reinforcing fabric within the cured liquid silicone rubber protects the reinforcing fabric from degradation due to contamination. Since the silicone rubber is gas permeable, the reinforced sheeting is especially useful for medical applications. Other advantages will be recognized by those of ordinary skill in the art.

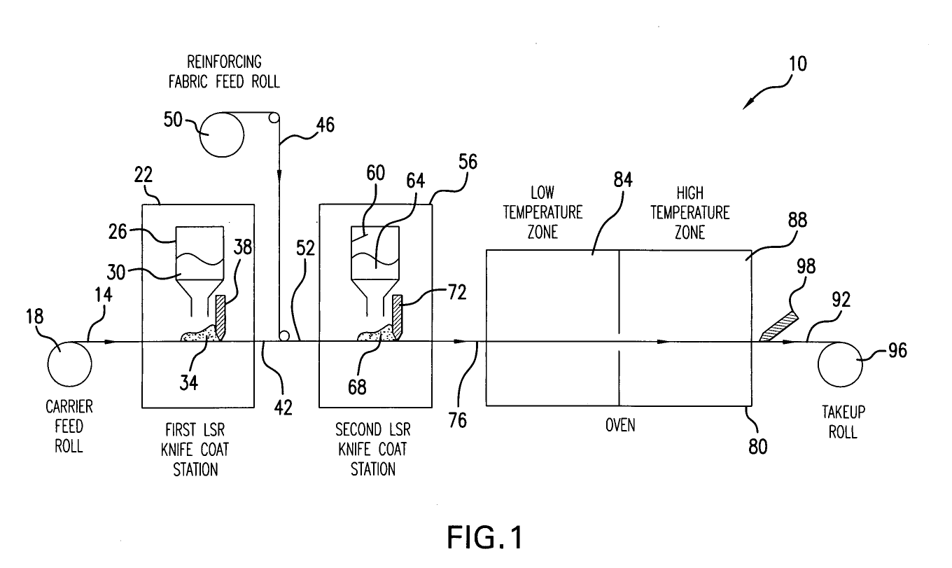

Referring now to FIGS. 1 and 8, a simplified schematic diagram of a method for making reinforced silicone rubber sheeting from liquid silicone rubber in accordance with one embodiment of the invention is shown. A manufacturing apparatus 10 is shown in schematic form.

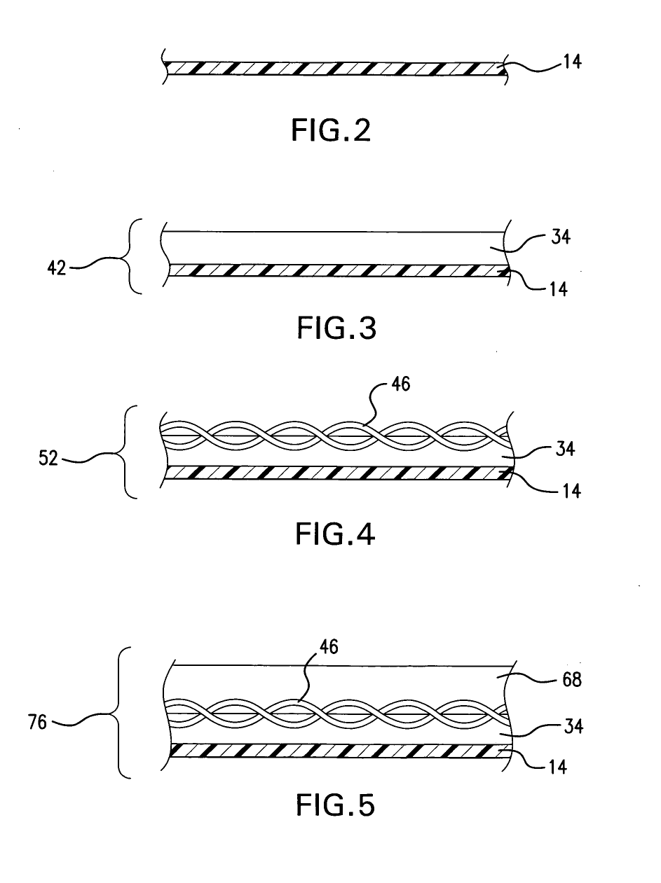

Referring again to FIG. 1, as an important feature of the present invention, a continuous carrier film 14 is provided. The continuous carrier film 14 may be any material capable of supporting uncured liquid silicone rubber and of withstanding a heat-curing cycle. Exemplary carrier films include, but are not limited to, polycarbonate, polyester, polyimide (Kapton™), and high temperature polyethylene. Preferably, the continuous carrier film has a thickness of between about 0.002 inches and 0.010 inches. The continuous carrier film 14 is preferably provided from a carrier feed roll 18. The continuous carrier film 14 is slowly pulled through the manufacturing apparatus by, for example, a stainless steel conveyor belt. A series of guides may additionally route, guide, tension, or press the continuous carrier film 14 as it traverses through the process. Preferably, the continuous carrier film 14 is slowly pulled forward at a process speed of between about 0.5 feet per minute and about 2.5 feet per minute. Referring now to FIG. 2, the partially-completed, reinforced silicone rubber sheeting 14 is shown in cross-section as the continuous carrier film 14 exits the carrier feed roll 18.

Referring again to FIG. 1, as an important feature of the present invention, a first layer 34 of uncured liquid silicone rubber (LSR) is applied onto the continuous carrier film 14 at the first liquid silicone rubber (LSR) knife coat station 22. The continuous carrier film 14 passes under a coating knife 38. The coating knife 38 scrapes away at the first layer 34 of uncured LSR such that only a carefully-controlled thickness of the first layer 34 of uncured LSR remains. Referring now particularly to FIG. 3, the partially-completed, reinforced silicone rubber sheeting 42 is shown after the first layer 34 of uncured LSR is knife-coated onto the continuous carrier film 14.

The knife-coated, first layer 34 of uncured first LSR is preferably a two-part, heat-cured, liquid silicone rubber. For example, an “A” component of organopolysiloxane polymer is combined with a “B” component of organosiloxane crosslinker. Referring again to FIG. 1, A and B components are combined and mixed in a mixer 26, or pump, to form a two-part LSR mix 30. The two-part LSR mix 30 may be mixed by hand or by an automated mixer. More preferably, the two-part LSR mix 30 is statically mixed by the pump of the delivery system without a separate mixer or mixing step.

Preferably, the first uncured LSR mix 30 has a low consistency, or viscosity, especially when compared to a high-consistency silicone. It is found that a low-consistency LSR can be easily mixed, pumped, and dispensed as a liquid or paste—without roller milling or calendering—such as are required for high-consistency silicone. The first uncured LSR mix 30 preferably has of a ratio of about 1:1 of polymer and crosslinker. This ratio is found to be optimal for mixing and pumping the LSR prior to application. However, other ratios, such as 10:1, may be used if the mixing and pumping mechanism is capable. The first uncured LSR mix 30 preferably includes a reaction catalyst, such as platinum. Alternatively, other catalysts, such as peroxide, may be used as known in the art. The first uncured LSR mix 30 preferably includes an inhibitor, such as acetylenic alcohol. Alternatively, other inhibitors may be used as are known in the art. Heating, during a later heat-curing step, evaporates the inhibitor from the first layer 34 of uncured LSR to allow the catalyst to cause cross-linking.

Alternatively, the first layer 34 of uncured LSR may be a silicone dispersion. In silicone dispersions, silicone solids are dispersed in a volatile liquid, such as xylene, isopropanol, or naphtha. The dispersion may be applied using knife-coating, just as with LSR. During subsequent heat curing, the volatile liquid evaporates leaving the silicone rubber solids to harden. Optionally, a crosslinker may be added to the dispersion, at the time of manufacture, to make the dispersion a two-part system.

As another important feature of the present invention, a continuous reinforcing fabric 46 is placed onto the first layer 34 of uncured LSR after the first LSR knife coat station 22 but before a second LSR knife coat station 56. Preferably, the continuous reinforcing fabric 46 is provided from an input reel 50. The continuous reinforcing fabric 46 is preferably pulled through the various processing steps by a series of rollers, or guides. The guides may additionally route, guide, tension, or press the continuous reinforcing fabric 46. Once the continuous reinforcing fabric 46 is applied to the first layer 34 of uncured LSR, the partially-completed reinforced sheeting 52 is pulled forward. Referring now to FIG. 4, the partially completed, reinforced sheeting 52 is shown in cross-section.

Proven continuous reinforcing fabrics 46 include, but are not limited to, polyester, nylon, aramid fabric (Kevlar™), and elastane (Spandex™). The continuous reinforcing fabric 46 may be any open, fine, woven, or knit mesh fabric capable of being encapsulated in liquid silicone. The continuous reinforcing fabric 46 thickness must be less than that of the intended, overall sheeting thickness such that the fabric 46 may be completely encapsulated by the first layer 34 of uncured LSR and a subsequently applied second layer 68 of uncured LSR.

Referring again to FIG. 1, as an important feature of the present invention, a second layer 68 of uncured LSR is applied onto the continuous reinforcing fabric 46 and the first layer 34 of uncured LSR at a second LSR knife coat station 56. The second layer 68 of uncured LSR is applied to the partially-completed reinforced sheeting 52 as it is pulled under through the second LSR knife coat station 56. The partially-completed sheeting 52 passes under another coating knife 72. The coating knife 72 scrapes away at the second layer 68 of uncured LSR such that only a carefully-controlled thickness of the second layer 68 of uncured LSR remains.

Referring now particularly to FIG. 5, the partially-completed, reinforced silicone rubber sheeting 76 is shown after the first layer 68 of uncured LSR is knife-coated onto the continuous reinforcing fabric 46 and the first layer 34 of uncured LSR. The continuous reinforcing fabric 46 is completely encapsulated, above and below, by the first layer 34 and second layer 68 of uncured LSR. As a result, the overall thickness of the completed sheeting is effectively and closely controlled by the knife coating operation. In addition, the continuous reinforcing fabric 46 is protected from the environment by silicone rubber after the first layer 34 and second layer 68 of uncured LSR are subsequently cured.

The knife-coated, second layer 68 of uncured first LSR is preferably a two-part, heat-cured, liquid silicone rubber. For example, an “A” component of organopolysiloxane polymer is combined with a “B” component of organosiloxane crosslinker. Referring again to FIG. 1, A and B components are combined and mixed in a mixer 60, or pump, to form a two-part LSR mix 64. The two-part LSR mix 64 may be mixed by hand or by an automated mixer. More preferably, the two-part LSR mix 64 is statically mixed by the pump of the delivery system without a separate mixer or mixing step. Preferably, the first layer 34 and second layer 68 of uncured LSR are the same composition. However, different LSR compositions may be used as long as a common heat-curing step will result in cross-linking and vulcanization of both layers.

Preferably, the second uncured LSR mix 64 has a low consistency, or viscosity, especially when compared to a high-consistency silicone. It is found that a low-consistency LSR can be easily mixed, pumped, and dispensed as a liquid or paste—without roller milling or calendering—such as are required for high-consistency silicones. The second uncured LSR mix 64 preferably has of a ratio of about 1:1 of polymer and crosslinker. This ratio is found to be optimal for mixing and pumping the LSR prior to application. However, other ratios, such as 10:1, may be used if the mixing and pumping mechanism is capable. The second uncured LSR mix 64 preferably includes a reaction catalyst, such as platinum. Alternatively, other catalysts, such as peroxide, may be used as known in the art. The second uncured LSR mix 64 preferably includes an inhibitor, such as acetylenic alcohol. Alternatively, other inhibitors may be used as are known in the art. Heating, during a later heat-curing step, evaporates the inhibitor from the second layer 68 of uncured LSR to allow the catalyst to cause cross-linking.

Alternatively, the second layer 68 of uncured LSR may be a silicone dispersion. In silicone dispersions, silicone solids are dispersed in a volatile liquid, such as xylene, isopropanol, or naphtha. The dispersion may be applied using knife-coating, just as with LSR. During subsequent heat curing, the volatile liquid evaporates leaving the silicone rubber solids to harden. Optionally, a crosslinker may be added to the dispersion, at the time of manufacture, to make the dispersion a two-part system.

As another important feature of the present invention, the first layer 34 and second layer 68 of uncured LSR are heat-cured. To heat cure the partially-completed reinforced sheeting 76, it is preferably pulled through a single oven with a low temperature zone 84 and a high temperature zone 88. Alternatively, the partially-completed reinforced sheeting 76 may be pulled through a sequence of two separate ovens. In the low temperature zone 84, the sheeting 76 is heated to between about 160 degrees F. and 220 degrees F. The first layer 34 and second layer 68 of LSR are flash heated to catalyze cross-linking and begin to vulcanize. In the high temperature zone 88 of the oven 80, the sheeting 76 is heated to between about 230 degrees F. and 300 degrees F. The first layer 34 and second layer 68 of LSR are completely vulcanized to further set the strength of the cured silicone rubber.

The heat curing process accelerates crosslinking within the first and second LSR layers, by any or all of (1) evaporating any inhibitor used to allow the catalyst to work, (2) accelerating the catalyzing of the crosslinker reaction, and (3) evaporating any volatile liquid used as a dispersant. In addition, the heat-curing step vulcanizes the silicone rubber to provide strength. After heat curing, the completed reinforced silicone rubber sheeting 92 is wound onto a take-up reel 96.

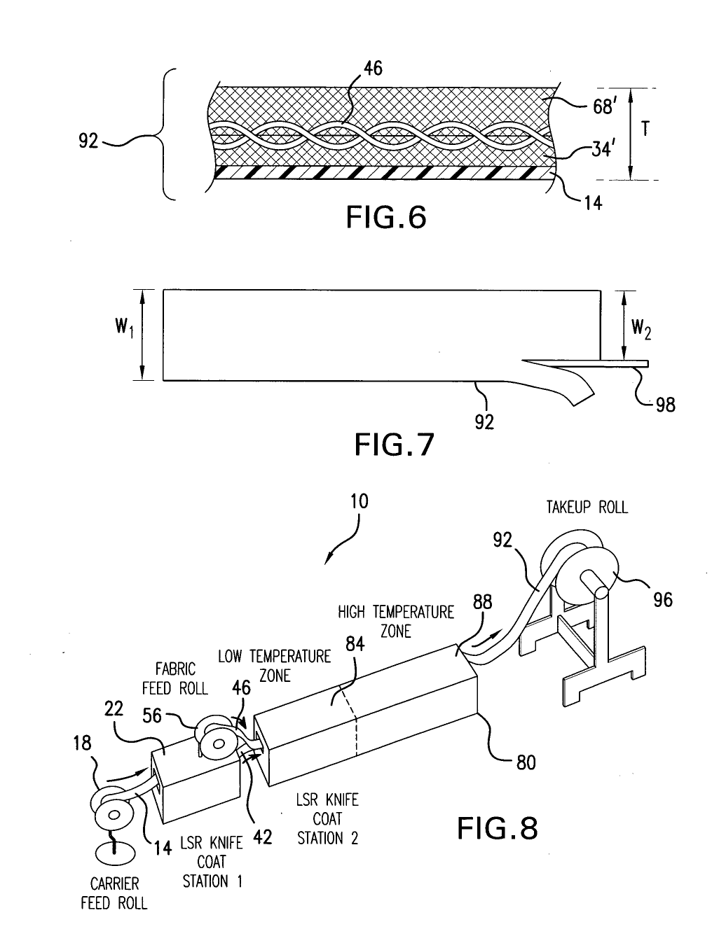

Referring now particularly to FIG. 6, the completed, reinforced silicone rubber sheeting 92 is shown after heat-curing. The first layer 34 and second layer 68 of LSR have been cross-linking and vulcanized to form a first layer 34′ and a second layer 68′ of silicone rubber. The method herein allows reinforced silicone rubber sheeting 92 to be produced at thickness (T) tolerances as small as +/−0.0005 inches. This is a unique and unexpected feature of the present invention that occurs due to knife-coating the LSR. The thickness T of the completed reinforced sheeting 92 is essentially controlled by the knife-coating steps. All raw materials are either automatically dispensed or automatically unspooled. There is little direct labor since hand layups and other labor intensive steps are avoided. The finished sheeting 92 is simply spooled onto a take-up reel at the end of the process. In addition, the method does not require complex milling, calendering equipment, or difficult-to-control machine setups.

As an optional feature, after heat-curing, the completed, reinforced silicone rubber sheeting 92 may be trimmed to a specific width by passing the sheeting 92 across a trimming knife 98. Referring now to FIG. 7, the completed, reinforced silicone rubber sheeting 92 is shown in top view, after heat-curing. By using liquid silicone rubber, a continuous reinforced silicone rubber sheeting 92 is formed. Maximum sheeting widths (W₁) of 17 inches or more have been achieved on continuous rolls of sheeting. Prior art methods to form reinforced silicone rubber sheeting from high-consistency silicone rubber are limited to small sheet sizes of 12 inches by 12 inches. The reinforced sheeting 92 may be trimmed, in process, to a smaller width (W₂) by passing the completed sheeting 92 across the trimming knife 98.

The above detailed description of the invention, and the examples described therein, has been presented for the purposes of illustration and description. While the principles of the invention have been described above in connection with a specific device, it is to be clearly understood that this description is made only by way of example and not as a limitation on the scope of the invention.

What is claimed is:

1. A method of forming reinforced silicone rubber sheeting comprising the steps of:
applying a first layer of uncured liquid silicone rubber onto a continuous carrier film;
thereafter placing a continuous reinforcing fabric onto the first uncured liquid silicone rubber layer;
thereafter applying a second layer of uncured liquid silicone rubber onto the continuous reinforced fabric to completely encapsulate the continuous reinforcing fabric within the first and second uncured liquid silicone layers; and
thereafter heat curing the first and second uncured liquid silicone rubber layers to complete a reinforced silicone rubber sheeting wherein the cured silicone rubber is gas-permeable but not a gel.

2. The method of claim 1 wherein the steps of applying the first and second uncured liquid silicone rubber layers each comprise pulling the continuous carrier film under a means of dispensing the uncured liquid silicone rubber and under a stationary knife.

3. The method of claim 1 wherein said heat curing further comprises the steps of:
heating to a first temperature of between about 160 degrees F. and about 220 degrees F.; and
thereafter, heating to a second temperature of between about 230 degrees F. and about 300 degrees F.

4. The method of claim 3 wherein said heat curing comprises pulling the sheeting through an oven having first and second heating zones.

5. The method of claim 1 further comprising the step of slitting the sheeting lengthwise after the step of heat curing to thereby adjust the width of the sheeting.

6. The method of claim 1 wherein the uncured liquid silicone rubber is a two-part mixture of organopolysiloxane polymer and organosiloxane crosslinker.

7. The method of claim 1 wherein the uncured liquid silicone rubber is a silicone dispersion.

8. The method of claim 1 wherein the uncured liquid silicone rubber has a ratio of polymer to crosslinker of between about 1:1 and 10:1.

9. The method of claim 1 wherein the carrier film is polycarbonate, polyester, polyimide (Kapton™), or high temperature polyethylene.

10. The method of claim 1 wherein the reinforcing fabric is polyester, nylon, aramid aramid fabric (Kevlar™), or elastane (Spandex™).

11. The method of claim 1 wherein the reinforcing fabric is open weave, fine weave, or knitted mesh.

12. A method of forming reinforced silicone rubber sheeting comprising the steps of:
applying a first layer of a two-part mixture of uncured liquid silicone rubber onto a continuous carrier film;
thereafter placing a continuous reinforcing fabric onto the first uncured liquid silicone rubber layer;
thereafter applying a second layer of the two-part mixture of uncured liquid silicone rubber onto the continuous reinforced fabric to completely encapsulate the continuous reinforcing fabric within the first and second uncured liquid silicone layers; and
thereafter heat curing the first and second uncured liquid silicone rubber layers to complete a reinforced silicone rubber sheeting, wherein the cured silicone rubber is gas-permeable but not a gel, and wherein the heat curing comprising the steps of:
heating to a first temperature of between 160 degrees F. and 220 degrees F.; and
thereafter, heating to a second temperature of between 230 degrees F. and 300 degrees F.

13. The method of claim 12 wherein the steps of applying the first and second uncured liquid silicone rubber layers each comprise pulling the continuous carrier film under a means of dispensing the uncured liquid silicone rubber and under a stationary knife.

14. The method of claim 12 wherein said heat curing comprises pulling the sheeting through an oven having first and second heating zones.

15. The method of claim 12 further comprising the step of slitting the sheeting lengthwise after the step of heat curing to thereby adjust the width of the sheeting.

16. The method of claim 12 wherein the uncured liquid silicone rubber is a two-part mixture of organopolysiloxane polymer and organosiloxane crosslinker.

17. The method of claim 12 wherein the uncured liquid silicone rubber is a silicone dispersion.

18. A reinforced silicone rubber sheeting comprising:
a continuous carrier film;
a cured liquid silicone rubber overlying the continuous carrier film wherein the cured liquid silicone rubber is gas-permeable but not a gel; and
a continuous reinforcing fabric completely encapsulated within the cured liquid silicone rubber.

19. The sheeting of claim 18 wherein the continuous carrier film is polycarbonate, polyester, polyimide (Kapton™), or high temperature polyethylene.

20. The sheeting of claim 18 wherein the reinforcing fabric is open weave, fine weave, or knitted mesh.
